(19) United States
(12) Patent Application Publication
(10) Pub. No.: US 2011/0081534 A1
(43) Pub. Date: Apr. 7, 2011

(54) PLASTICS FILM

(76) Inventor: Charles Watkinson, Yorkshire (GB)

(21) Appl. No.: 12/867,022

(22) PCT Filed: Feb. 6, 2009
(86) PCT No.: PCT/GB09/00356

§ 371 Date: Dec. 3, 2010

(30) Foreign Application Priority Data
Feb. 11, 2008 (GB) 0802508.2

(51) Int. Cl. B32B 5/00

(52) U.S. Cl. 428/220

(57) ABSTRACT

A plastics or other film incorporates a filler comprising glassflakes with an average thickness of from 10 to 2000 nm. Products which may be formed from this film include a sleeve, protective packaging, a bag, a liner, a house-wrap, an over-wrap film, bubble and cushion film, packaging for food products, a boil-in-bag, a heat shrinkable film or bag, a pouch and a thermoformed package.

### FIELD OF THE INVENTION

This invention relates to plastics film which is made from suitable polymeric or other material, especially a thermoplastics material. Such plastics film has wide use in, for instance, packaging and related industries.

### BACKGROUND TO THE INVENTION

Thermoplastics materials are widely used in packaging because of their low cost and the ease of forming them into a variety of shapes and wrapping capabilities. However, in general, such materials suffer from the disadvantage of providing only a relatively poor barrier to gas and vapour diffusion and to chemical and/or aroma contamination.

The provision of a poor gas barrier is a particular disadvantage in packaging. Oxygen-sensitive materials, such as foodstuffs which are to be stored unrefrigerated, can deteriorate quickly due to the presence of oxygen.

Furthermore, poor vapour barrier properties are a serious disadvantage when materials such as foodstuffs and confectionery are being packed since they are liable to deteriorate when they become damp. There are also disadvantages when the packed material includes flavouring components which diffuse through the packaging material with a consequential loss of flavour.

Bottles containing carbonated drinks can lose the gas, allowing the contents to become flat.

Poor chemical/aroma resistance is a disadvantage when packing materials are used to store, for example, waste products. In the case of foodstuffs loss of aroma may occur.

The barrier properties of a polymer composite film can be improved by the addition of impermeable plate-like structures. When the plates are oriented perpendicular to the direction of diffusion or permeation, the diffusing molecules most go around the plates. This leads to a significant increase in path length which the moisture or gas has to travel within the film and reduces considerably the permeability of the polymer.

Such fillers have included exfoliated silicate nano-clays, talcum powders and other lamellar type fillers such as mica.

Flake particulates previously available and sufficiently thin comprise mica and silica flake. Mica has a thickness of about 300 nm to 500 nm. The silica flake produced from clays such as montmorillionite is from 1 nm to 4 nm in thickness and the artificial silica flake produced by the sol-gel process is about 350 nm in thickness.

These flake particulates all have disadvantages for use as permeation blockers and inhibitors, not the least of which is that the first two are naturally occurring and their thicknesses are not suitable for many applications and cannot be changed.

The artificial silica flake is limited in its thickness range but also very costly.

Generally, these three types of flakes are either too thin or too thick for applications in packaging or have other disadvantages.

### STATEMENTS OF THE INVENTION

According to the present invention there is provided a plastics or other film incorporating a filler comprising glass flake with an average thickness of from 10 to 2000 nm.

Glass flake has several advantages including cost and the fact that the thickness can be tailored to a particular application. Furthermore, the composition can be varied and can be designed to release chemical compounds or ions which are suitable to give particular properties such as fungal inhibition.

Glass flake of use in the present invention may be made by, for instance, a process as described in European Patent No EP 0289240 and also as described in PCT Patent Application No. PCT/GB2008/003230. Such a process involves the use of a spinning cup to produce a flat film of molton glass emanating radially from the rim of the cup. The film is fed between two plates forming an annular venturi and is super-cooled with forced air. The film is broken up due to the high velocity air stream and the drag (frictional resistance) imparted by it.

The parameters involved in producing a flat glass flake of even thickness are varied and complex. They include:
glass composition, melt temperature and viscosity
temperature of glass in the melt tank
mass flow of glass leaving the tank and entering the cup
temperature of the glass entering the cup
distance between the outlet of the glass tank and entry to the cup
diameter and depth of the cup
heat dissipation properties of the cup
rotation and speed of the cup
distance between the rim of the cup and entry to the radial venturi
distance between the plates forming the radial venturi
diameter of the venturi plates
volume and pressure of air being drawn between the venturi plates
temperature of the air flowing between the venturi plates
diameter and construction of the cyclone.

These parameters can all be varied with the result that the glass flakes either are or are not produced. Flakes, if produced, may be flat or wavy, they may be of substantial variation in thickness or very consistent in thickness. The flakes may be large or small or in cross-section. Such a method may be used to produce flakes of any desired thickness within the range of those of use in the present invention.

Incorporation of glass flake into a suitable polymeric or other film may reduce or inhibit the permeation of the film by various materials including gases, vapours, chemicals or aroma. Furthermore, the glass flake can enhance properties including mechanical strength, rigidity or flexural modulus, heat distortion temperature and tear strength. Furthermore, the nucleation characteristics and fire resistance characteristics of the film may be improved.

Preferably, the average thickness of the glass flake is from 40 to 1000 nm.

Preferably, the average particle size of the glass flake is from 5 to 1000 microns.

Preferably, the glass flake is selected from one or more of a C or E type glass, a low alkaline glass, an ECR glass, a phosphate glass and a water-soluble composition.

The film may be a single layer film or a multi layer film. Where the film is a multi-layer film the glass flake may be contained in at least one layer of the film. Alternatively or additionally, the glass flake may be located between two adjacent layers of the film.

Preferably the glass flake amounts to from 0.5 to 75% by weight of the total weight of the film. More preferably, the glass flake amounts to from 2 to 30% of the total weight of the film.

The film may be made from any suitable polymer or copolymer, for instance one selected from one or more of a polyolefin, a polyester, PET, PBT and an acrylic polymer. For instance, the film may be made from polypropylene.

The glass flake may be coated with an agent having a first chemical group that is reactive with the glass flake and a second chemical group that is reactive with the film. An example of such an agent is a silane or a polysilane.

The glass flake may be treated with a stearate to aid incorporation and leafing when incorporated directly into the film.

The glass flake may be loaded with a material which is capable of slow release under general or particular conditions. For instance, the glass flake may be loaded with silver or other ions which are released from the flake. The release may be when the film comes into contact with vapour and the release material acts as a biocidal or fungal growth inhibitor.

Films of the present invention may be incorporated in a variety of different products. Examples of such products are sleeves, protective packaging films, bags, liners, house-wraps, over-wrap films bubble and cushion film, packaging for food products, boil-in bags, heat shrinkable films, heat shrinkable bags, pouches and thermoformed packages.

1. A plastics or other film incorporating a filler comprising glass flakes with an average thickness of from 10 to 2000 nm.

2. A film according to claim 1, wherein said average thickness is from 40 to 1000 nm.

3. A film according to claim 1, wherein the average particle size of the glass flake is from 5 to 1000 microns.

4. A film according to claim 1, wherein the glass flake is selected from one or more of a C or E type glass, a low alkaline glass, an ECR glass, a phosphate glass and a water-soluble composition.

5. A film according to claim 1, wherein the film is a single layer film.

6. A film according to claim 1, wherein the film is a multi-layer film.

7. A film according to claim 6, wherein the glass flake is contained in at least one layer of the film.

8. A film according to claim 6, wherein the glass flake is located between two adjacent layers of the film.

9. A film according to claim 1, wherein the glass flake amounts to from 0.5 to 75% by weight of the total weight of the film.

10. A film according to claim 9, wherein the glass flake amounts to from 2 to 30% by weight of the said weight of the film.

11. A film according to claim 1, wherein the film is made from a polymer or copolymer selected from one or more of a polyolefin, a polyester, PET, PBT and an acrylic polymer.

12. A film according to claim 11, wherein the film is made from polypropylene.

13. A film according to claim 1, wherein the glass flake is coated with an agent having a first chemical group that is reactive with the glass flake and a second chemical group that is reactive with the film.

14. A film according to claim 13, wherein the agent is a silane or polysilane.

15. A film according to claim 1, wherein the glass flake is treated with stearate.

16. A film according to claim 1, wherein the glass flake is loaded with silver or other ions which are released from the flake.

17. A film according to claim 16, wherein the release from the flake includes release into contacting vapour whereby the released material acts as a biocidal or fungal growth inhibitor.

18. A product formed from the film of claim 1.

19. A product according to claim 18, wherein the product is any one of a sleeve, protective packaging, a bag, a liner, a house-wrap, an over-wrap film, bubble and cushion film, packaging for food products, a boil-in bag, a heat shrinkable film or bag, a pouch and a thermoformed package.
